(19) United States
(12) Patent Application Publication
(10) Pub. No.: US 2015/0002344 A1
(43) Pub. Date: Jan. 1, 2015

(54) ANTENNA DEVICE FOR VEHICLE

(71) Applicant: Hyundai Motor Company, Seoul (KR)

(72) Inventors: Tae Inn CHUNG, Gwangju (KR); Tae Hwan YOO, Incheon (KR)

(73) Assignee: HYUNDAI MOTOR COMPANY, Seoul (KR)

(21) Appl. No.: 14/099,726

(22) Filed: Dec. 6, 2013

(30) Foreign Application Priority Data
Jul. 1, 2013 (KR) 10-2013-0076565

(51) Int. Cl. H01Q 1/32; H01Q 21/00

(52) U.S. Cl. CPC H01Q 1/32; H01Q 21/00
USPC 343/702; 343/893

(57) ABSTRACT

An antenna device for a vehicle includes an antenna case, a main antenna and a preliminary antenna. The antenna case has a board disposed therein. The main antenna is connected to the board through a connector of the antenna case. The preliminary antenna is disposed inside the antenna case and connected to the board. The preliminary antenna is configured to perform a function of transmitting and receiving frequency signals.

### CROSS-REFERENCE TO RELATED APPLICATION

This application is based on and claims benefit of priority to Korean Patent Application No. 10-2013-0076565 filed Jul. 1, 2013, the entire contents of which are incorporated herein by reference.

### TECHNICAL FIELD

The present inventive concept relates to an antenna device for a vehicle for mobile services. More particularly, the present inventive concept relates to an antenna device for a vehicle, which can continuously maintain mobile services even when a pole-type main antenna mounted to the vehicle is broken down.

### BACKGROUND

As communication devices are developed, several antennas for receiving frequencies of an FM/AM radio, DMB frequencies, frequencies of a remote keyless entry (RKE) system, etc. have recently been mounted inside/outside of a vehicle.

For example, an antenna for receiving FM/AM radio frequencies, an antenna for receiving DMB frequencies, an antenna for receiving RKE frequencies, etc. are frequently mounted to a vehicle. Here, the antenna for receiving FM/AM radio frequencies may be of a pole type in which a flexible pipe composed of some stages can be vertically controlled, and the antenna for receiving DMB frequencies may be of a monopole type having a ¼ wavelength. The antenna for receiving RKE frequencies may be mounted inside a vehicle so as to receive an RKE signal from an external transmitter within a certain radius.

Recently, there has been proposed an integrated antenna in which a GPS antenna, a code division multiple access (CDMA) antenna and a helical antenna for receiving radio frequencies and DMB frequencies are mounted inside a shark-fin-shaped case.

Meanwhile, with the development of electronic communication technologies, the use of a mobile telematics system on the wireless Internet is rapidly extended as well as a cellular phones using simple voice. The mobile telematics system is applied to most vehicles, thereby providing convenience such that various kinds of information can be transmitted to/received from inside a driving vehicle.

To this end, various services of positioning information, and Internet and traffic information are provided through an antenna for mobile services, mounted to a roof or the like of a vehicle.

Various types of antennas for mobile services have been disclosed in Korean Patent Application Publication No. 10-2004-0033658, etc.

FIG. 5 is a perspective view showing a conventional antenna for mobile services.

As shown in FIG. 5, the antenna for mobile services includes an antenna case 100 having a printed circuit board (PCB) (not shown) built therein, an antenna pole 120 connected to a connector 110 of the antenna case 100, and an antenna wire 130 mounted inside the antenna pole 120. The antenna for mobile services is fixed to a roof of a vehicle through the antenna case 100.->Correct!!

Here, the antenna wire 130 is connected to the connector 110 that is connected to the PCB, so as to transmit or receive frequency signals.

However, when the antenna pole erected from the antenna case is broken down by being bumped or hit against another object, the conventional antenna for mobile services cannot perform an antenna function for mobile services (e.g., telematics) any more. When the antenna pole is broken down as described above, e.g., when the antenna wire in the antenna pole is broken down, the antenna cannot receive a mobile service such as a blue link service or emergency SOS (e-call) service. Moreover, there is a problem in layout and increased cost when two or more antennas should be unavoidably used.->OK!!

### SUMMARY

The present inventive concept provides an antenna device for a vehicle, which includes a pole-type main antenna mounted to the vehicle for the purpose of mobile services and a preliminary antenna capable of alternatively performing the function of the main antenna, so that it is possible to continuously maintain the mobile services even when the main antenna is broken down.

One aspect of the present inventive concept relates to an antenna device for a vehicle, including: an antenna case having a board mounted therein; a main antenna connected to the board through a connector of the antenna case; and a preliminary antenna mounted inside the antenna case to be connected to the board, the preliminary antenna performing a function of transmitting and receiving frequency signals.

The preliminary antenna may include a nonconductive shield can mounted on the board in the antenna case, and a conductive antenna pattern portion attached to an outer wall surface of the shield can. A shielding paint layer may be coated on an inner wall surface of the shield can.

An end of the antenna pattern, extended to a bottom end of the shield can, may be connected to the board.

In an antenna device for the vehicle according to the present inventive concept, a separate preliminary antenna for mobile services is provided inside an antenna case while maintaining the existing antenna mounted to a vehicle, so that when the existing antenna is broken down, antenna functions for mobile services can be continuously performed using the preliminary antenna. Thus, a driver does not feel inconvenient in using mobile services. Accordingly, it is possible to continuously provide various convenient services related to the use of mobile services.

### BRIEF DESCRIPTION OF THE DRAWINGS

The foregoing and other features of the inventive concept will be apparent from more particular description of embodiments of the inventive concept, as illustrated in the accompanying drawings in which like reference characters may refer to the same or similar parts throughout the different views. The drawings are not necessarily to scale, emphasis instead being placed upon illustrating the principles of the embodiments of the inventive concept.

FIGS. 1 to 3 are perspective and sectional views showing an antenna device for a vehicle according to an embodiment of the present inventive concept.

FIG. 4 show enlarged and sectional views of a preliminary antenna according to an embodiment of the present inventive concept.

FIG. 5 is a perspective view showing a conventional antenna for mobile services.

It should be understood that the appended drawings are not necessarily to scale, presenting a somewhat simplified representation of various preferred features illustrative of the basic principles of the present inventive concept. The specific design features of the present inventive concept as disclosed herein, including, for example, specific dimensions, orientations, locations, and shapes will be determined in part by the particular intended application and use environment.

In the figures, reference numbers refer to the same or equivalent parts of the present inventive concept throughout the several figures of the drawing.

### DETAILED DESCRIPTION

Hereinafter reference will now be made in detail to various embodiments of the present inventive concept, examples of which are illustrated in the accompanying drawings and described below. While the present inventive concept will be described in conjunction with exemplary embodiments, it will be understood that present description is not intended to limit the present inventive concept to those exemplary embodiments. On the contrary, the present inventive concept is intended to cover not only the exemplary embodiments, but also various alternatives, modifications, equivalents and other embodiments, which may be included within the spirit and scope of the present inventive concept as defined by the appended claims.

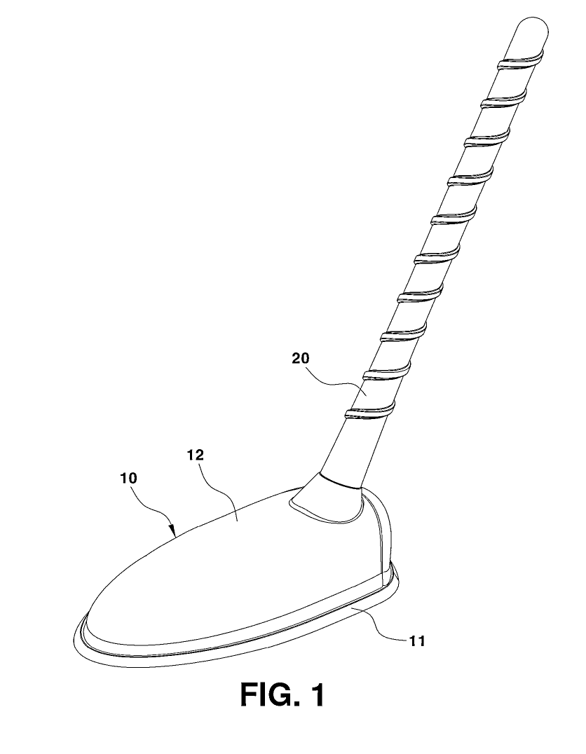

The present inventive concept provides an antenna device for a vehicle for mobile services. Particularly, referring to FIGS. 1-3, a preliminary antenna 30 capable of performing antenna functions for mobile services may be provided inside an antenna case 10. With the preliminary antenna 30, it is possible to implement a new type antenna device for mobile services, which can substitute for a main antenna 20 when the main antenna 20 is broken down.

As shown in FIGS. 1 to 3, the antenna device according to an embodiment of the present inventive concept may be a pole antenna, and may have a structure including a main antenna 20 and a preliminary antenna 30 capable of substituting for the main antenna 20. Thus, when the main antenna 20 is broken down, the antenna device can maintain mobile services without any problem, using a combination of the main antenna 20 and the preliminary antenna 30.

To this end, the antenna device may include the antenna case 10, the main antenna 20 and the preliminary antenna 30.

The antenna case 10 may be mounted to a roof or the like of the vehicle. In this case, the antenna case 10 may have a structure in which a base 11 and a cover 12 are coupled to each other. Here, the base 11 may be fixed to the roof or the like of the vehicle, and the cover 12 may provide a predetermined internal space while finishing an upper portion of the base 11.

A board 13 such as a printed circuit board (PCB) may be mounted inside the antenna case 10. A connector 14 having an antenna wire 21 connected thereto may be connected to the board 13 mounted as described above.

The main antenna 20 extended upward from the antenna case 10 may be mounted at a rear end portion of the antenna case 10. Here, the main antenna 20 may have a rear end supported by the antenna case 10.

The main antenna 20 may be of a pole antenna type, and may include the antenna wire 21 mounted in the inside thereof. The rear end of the main antenna 20 may be supported by the antenna case 10. For example, the main antenna 20 may be supported by being coupled to the cover 12 of the antenna case 10. In addition, the antenna wire 21 may be connected to the connector 14 that is coupled to the cover 12 of the antenna case 10 by a screw fastening structure.

In this case, the connector 14 may include a connector body 14a and a connector pin 14b. The connector body 14a may be connected to the antenna wire 21, and the connector pin 14b may be connected to the board 13.

Here, the entire main antenna 20 including the antenna wire 21 may be supported and connected to the antenna case 10 through the connector 14 of the antenna case 10. The antenna wire 21 may be connected to the board 13 through the connector 14. The connector 14 and the board 13 may be connected to each other.->OK!!

The board 13 may perform the function of a receiving circuit and include a receiving module (not shown) for receiving frequency signals of mobile services, etc.

The main antenna 20 and the preliminary antenna 30 may be configured to receive frequency signals of mobile services and convert the received frequency signals into electrical control signals.

Particularly, when the antenna device is broken down, e.g., when the main antenna 20 and the antenna wire 21 are broken down, the present inventive concept provides the preliminary antenna 30 as a means capable of substituting for the functions of the antenna pole 12 and the antenna wire 13.

That is, when the main antenna 20 does not perform its own function due to its breakdown or the like, the present inventive concept provides the preliminary antenna 30 for performing antenna functions while transmitting and receiving frequency signals, in place of the main antenna 20.

The preliminary antenna 30 may be implemented using an antenna pattern suitable for frequencies of mobile services. In this case, the antenna pattern may be formed in various shapes according to the frequencies.

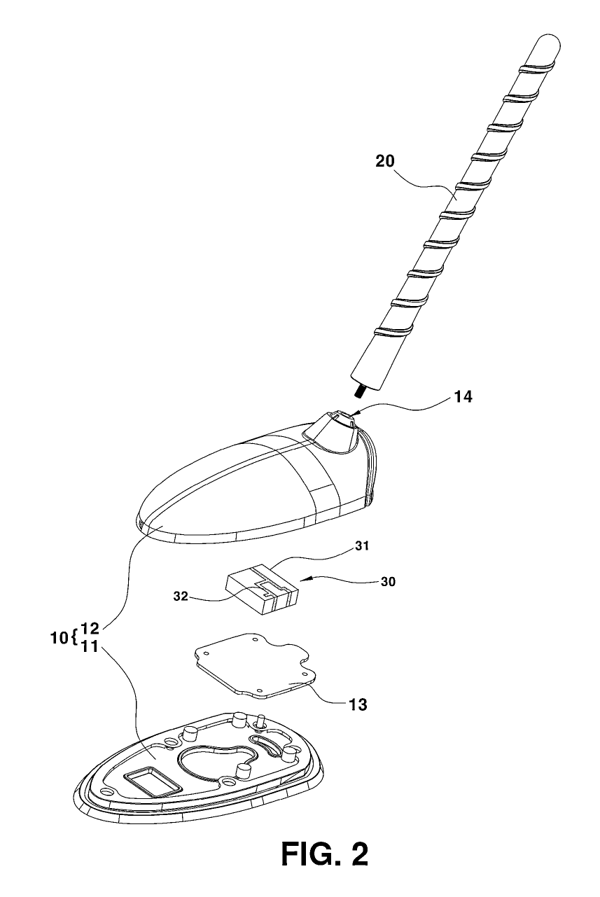

As one example, the preliminary antenna 30, as shown in FIGS. 2 to 4, may have a nonconductive shield can 31 and a conductive antenna pattern portion 32 formed on the shield can 31.

The shield can 31 may have a box structure having an opened bottom surface, and may be made of a nonconductive material such as plastic. The shield can 31 may be mounted on the board 13 mounted in the antenna case 10.

The antenna pattern portion 32 may perform antenna functions while substantially transmitting and receiving frequency signals of mobile services. The antenna pattern portion 32 may have the shape of a thin film having a predetermined pattern, and may be made of a conductive material. The antenna pattern portion 32 may be attached on an outer wall surface of the shield can 31.

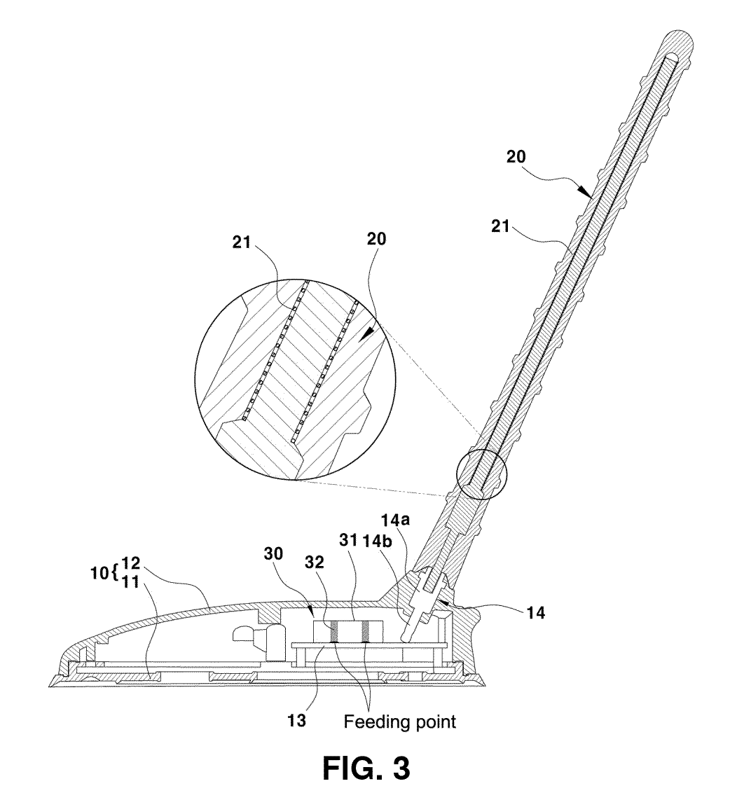

That is, the antenna pattern portion 32 may be patterned in a predetermined pattern according to the frequency signals of mobile services to be received and transmitted, so as to be attached on the outer wall surface of the shield can 31. The antenna pattern portion 32 configured as described above can perform the antenna functions by allowing a feeding point (see FIG. 3) at an end of the antenna pattern portion 32, to extend to a bottom end of the shield can 31 and to be connected to the board 13 through soldering or the like.

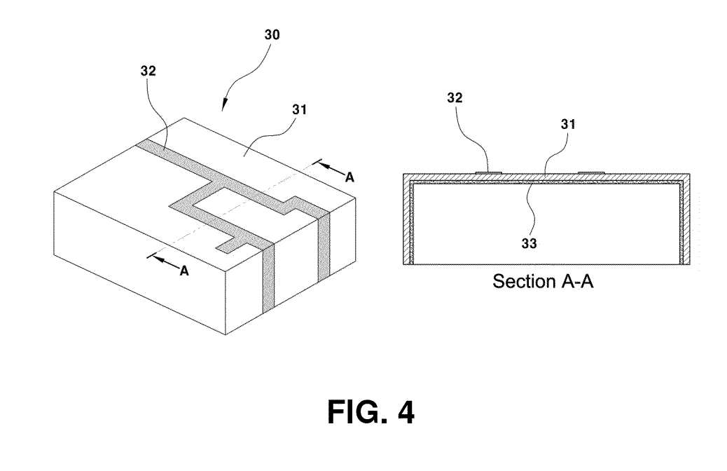

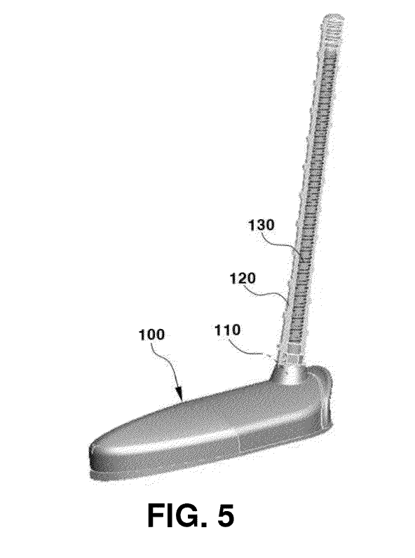

In addition to the preliminary antenna 30, a component (not separately shown) constituting a circuit may be mounted on the board 13 having the shield can 31 mounted thereon. A shielding paint layer 33 (see FIG. 4) may be preferably coated on an inner wall surface of the shield can 31 in order to eliminate electro magnetic interference (EMI) of the component mounted on the board 13.

The shielding paint layer 33 may be formed by coating EMI shielding paint on the inner wall surface of the shield can 31.

Thus, the antenna device having the preliminary antenna and the main antenna, which is mounted to the vehicle as described above, can perform antenna functions by transmitting and receiving frequency signals through the antenna device. Although the existing main antenna may be broken down, the antenna device according to the present inventive concept can maintain mobile services without any problem. When the main antenna is broken down, the preliminary antenna mounted in the antenna case may perform antenna functions for mobile services, in place of the main antenna, so that the driver does not feel inconvenient in using mobile services (telematics and the like).

The present inventive concept has been described in detail with reference to exemplary embodiments thereof. However, it will be appreciated by those skilled in the art that changes may be made in these embodiments without departing from the principles and spirit of the present inventive concept, the scope of which is defined in the appended claims and their equivalents.

What is claimed is:

1. An antenna device for a vehicle, comprising:
an antenna case having a board disposed therein;
a main antenna connected to the board through a connector of the antenna case; and
a preliminary antenna disposed inside the antenna case and connected to the board, the preliminary antenna being configured to perform a function of transmitting and receiving frequency signals.

2. The antenna device of claim 1, wherein the preliminary antenna includes a nonconductive shield can disposed on the board in the antenna case, and a conductive antenna pattern portion attached to an outer wall surface of the shield can.

3. The antenna device of claim 2, wherein a shielding paint layer is coated on an inner wall surface of the shield can.

4. The antenna device of claim 2, wherein an end of the antenna pattern portion extends to a bottom end of the shield can, and is connected to the board.

5. The antenna device of claim 2, wherein the antenna pattern portion includes a predetermined pattern having a conductive material.->OK!!

6. The antenna device of claim 2, wherein the shield can includes a plastic material and has a box structure having an opened bottom surface.

7. An antenna device for a vehicle, comprising:
a main antenna connected to the board through a connector of the antenna case; and
a preliminary antenna having a predetermined antenna pattern according to frequency signals of mobile services to be received and transmitted, the preliminary antenna being configured to perform a function of transmitting and receiving the frequency signals.

8. The antenna device of claim 7, further comprising an antenna case having a board disposed therein.

9. The antenna device of claim 8, wherein the preliminary antenna includes a nonconductive shield can disposed on the board in the antenna case, and a conductive antenna pattern portion attached to an outer wall surface of the shield can.

10. The antenna device of claim 9, wherein a shielding paint layer is coated on an inner wall surface of the shield can.

11. The antenna device of claim 9, wherein an end of the antenna pattern portion extends to a bottom end of the shield can, and is connected to the board.

12. The antenna device of claim 9, wherein the predetermined antenna pattern includes a conductive material and is included in the antenna pattern portion.->OK!!

13. The antenna device of claim 9, wherein the shield can includes a plastic material and has a box structure having an opened bottom surface.
